(19) United States
(12) Patent Application Publication
(10) Pub. No.: US 2020/0324206 A1
(43) Pub. Date: Oct. 15, 2020

(54) METHOD AND SYSTEM FOR ASSISTING GAME-PLAY OF A USER USING ARTIFICIAL INTELLIGENCE (AI)

(71) Applicant: FalconAI Technologies, Inc., Cambridge, MA (US)

(72) Inventors: Olcay Yilmazcoban, Istanbul (TR); Berk Ozer, Istanbul (TR)

(21) Appl. No.: 16/378,842

(22) Filed: Apr. 9, 2019

(51) Int. Cl. A63F 13/67; A63F 13/352; G06N 3/08; G06N 20/00

(52) U.S. Cl. CPC A63F 13/67; G06N 20/00; G06N 3/08; A63F 13/352

(57) ABSTRACT

The invention provides a method and system for assisting game-play of a user. The method and system includes a training module to train an Artificial Intelligence (AI)-based learning model based on a plurality of offline features and a plurality of online features. The plurality of offline features are extracted from one or more of data collected by one or more game developers, a plurality of Application Programming Interfaces (APIs) and a plurality of replay files associated with game-play. On the other hand, the plurality of online features are extracted from a screen state of the user. Further, the method and system includes a coaching module to coach the user in game-play utilizing the AI-based learning model using techniques such as, but not limited to, statistics, post-game analysis and progress tracking of game-play for optimizing the performance of the user, and generates one or more game-play suggestions for the user.

### FIELD OF THE INVENTION

The invention generally relates to assisting game-play of a user using Artificial Intelligence (AI) techniques. Specifically, the invention relates to a method and system for assisting the game-play of the user by providing coaching to the user in game-play using a trained AI-based learning model for optimizing the performance of the user and generating one or more game-play suggestions for the user.

### BACKGROUND OF THE INVENTION

Playing video games is becoming increasingly complex with advancements in the video gaming technology. Initially, every player involved in a video game is provided with a predefined set of rules such as, but not limited to, the dos and don'ts to be considered by the player, wherein the predefined set of rules are provided in detail to the player before the commencement of the game and during game-play. To achieve a goal in the game, a linear sequence of events is presented to the player and the player is required to respond with a linear sequence of actions. However, the predefined set of rules and the linear sequence of events restricts the player from moving in different paths to attain the goal.

Conventionally, the predefined set of rules for playing video games are hassle-free and allow video games to be open-ended, where the player freely interacts in any manner, performs any action and progresses differently in the video game. However, the freedom provided to the players with the predefined set of rules confuses new players who are unfamiliar with the video game and challenges a game developer with respect to creating an effective game experience for the new players. Typically, the video game code aids or adapts the video game in accordance with several possible scenarios and the video game code is improved to provide a more adaptive game assistance.

Further, the popularity and complexity of video games has increased over the years, providing two and three dimensional high-definition graphics, complex game-play, and challenging puzzles to the players. The trends and innovations created in the field of video games has led to an increase in quality of gaming and enhancement of user experience during game-play, at the same time increasing complexities of game-play. To overcome these complexities, the player of the game is provided more assistance or help while playing the game. However, the player encounters multiple disruptions in accessing assistance from an internet search while playing the game and this potentially degrades the gaming experience for the player.

Moreover, many conventional video game systems utilize complex branching programs that dictate conduct of characters in the game and provide outcome of game situations in response to status of specific operating parameters. Traditional role-playing games allow the player to control the development of character in the game based on response received for specific queries, options, decisions, and interactions from other characters. However, the video game systems are deficient, because the video game systems do not feature game characters that evolve or learn from experience, age, and/or function in accordance with many different traits. In addition, most of the video gaming systems do not allow end users to breed, develop, train, and compete with the game characters over time.

Also, a new market in the video gaming industry is Esports (electronic sports), or competitive gaming, that is currently exploding across the globe. Esports relates to a form of competition that is facilitated by electronic systems, particularly video games. With Esports, the input of players and teams as well as the output of the Esports system are mediated by human-computer interfaces. Most commonly, Esports takes the form of organized, multiplayer video game competitions, particularly between professional players. Existing coaching or training techniques in Esports involve human coaches who are both expensive and time consuming, and computer systems used for such training purposes do not provide action plans to the user. Further, it is widely known in Esports that getting into slumps and losing matches in a streak happens to players from time to time.

To address this, existing coaching techniques employ only human coaches to provide indication to players of the need to take a small break and to advance stronger, and therefore lack automation.

Therefore, in light of the above, there is a need for a method and system for providing an improved mechanism of coaching or training players in the competitive online gaming environment, especially Esports.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a system for assisting game-play of a user in accordance with an embodiment of the invention.

FIG. 2 illustrates a flowchart of a method for assisting game-play of a user in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and system components related to assisting game-play of a user by coaching the user in game-play utilizing an Artificial Intelligence (AI)-based learning model, which is trained based on a plurality of offline features and a plurality of online features, and generating one or more game-play suggestions for optimizing the performance of the user.

Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article or composition that comprises a list of elements does not include only those elements but may include other elements not expressly listed or inherent to such process, method, article or composition. An element proceeded by “comprises . . . a” does not, without more constraints, preclude the existence of additional identical elements in the process, method, article or composition that comprises the element.

Various embodiments of the invention provide a method and system for assisting game-play of a user. The method and system includes a training module to train an Artificial Intelligence (AI)-based learning model based on a plurality of offline features and a plurality of online features collected using a data collection module. The plurality of offline features are extracted from one or more of data collected by one or more game developers, a plurality of Application Programming Interfaces (APIs) and a plurality of replay files associated with game-play. On the other hand, the plurality of online features are extracted from a screen state of the user. Further, a coaching module is configured to coach the user in game-play utilizing the AI-based learning model that is trained based on the plurality of offline and online features, using techniques such as, but not limited to, statistics, post-game analysis and progress tracking of game-play, for optimizing the performance of the user. Further, the coaching module generates one or more game-play suggestions for the user.

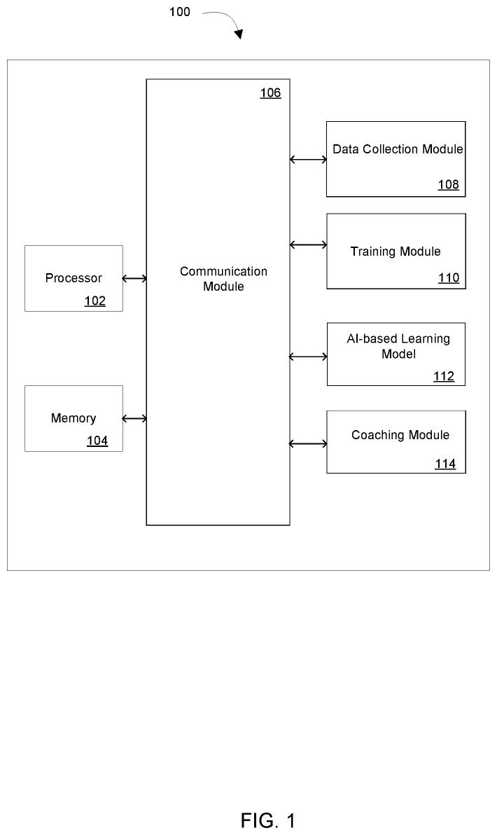

FIG. 1 illustrates a system 100 for assisting game-play of a user in accordance with an embodiment of the invention.

As illustrated in FIG. 1, system 100 includes a processor 102 and a memory 104 communicatively coupled to processor 102. Processor 102 and memory 104 further communicate with various modules via a communication module 106. Communication module 106 may be configured to transmit data between modules, engines, databases, memories, and other components of system 100 for use in performing the functions discussed herein. Communication module 106 may include one or more communication types and utilize various communication methods for communication within system 100.

System 100 includes a data collection module 108 for collecting a plurality of offline features and a plurality of online features related to the user's game-play. The game-play may include, but need not be limited to, an online game-play, a video game-play, a competitive video game-play, Electronic Sports (Esports) and the like.

Data collection module 108 extracts the plurality of offline features from one or more of data collected by one or more game developers, a plurality of Application Programming Interfaces (APIs) and a plurality of replay files associated with game-play.

The plurality of APIs may include, but need not be limited to, official APIs and unofficial APIs. Official APIs are provided by game developers that serve statistics about matches including the user's individual performance. On the other hand, unofficial APIs are third-party platforms that parse and process replay files, and extract much more information about the game-play and serve this information using their own API.

The plurality of replay files associated with game-play are used as a most complete data source which stores complete information about a match as encoded event streams. These event streams can be decoded, parsed and processed to extract any in-game detail for learning the game-play. Open source projects may be used for parsing the plurality of replay files which can be extended and customized to the project's needs.

Data collection module 108 extracts the plurality of online features from a screen state of the user using computer vision and image processing techniques. The computer vision and image processing techniques include one or more of convolutional neural networks, a low-pass filtering and colour detection to estimate a location of the user and states of all units from a mini-map.

The plurality of offline features and the plurality of online features that are extracted by data collection module 108 are then utilized by a training module 110 to train an Artificial Intelligence (AI)-based learning model 112.

Training module 110 trains AI-based learning model 112 based on the plurality of offline features, which includes engineering a plurality game-play performance features that are used in one or more neural network structures, deep learning and computer vision techniques, to prepare a roadmap of the user.

Training module 110 further trains AI-based learning model 112 to learn the user's gaming behaviour using various techniques which include, but need not be limited to, specific rule-based methods and more complex AI structures.

In an embodiment, AI-based learning model 112 utilizes specific methods implementing rule based algorithms to be used in various tasks such as, but not limited to, role determination, analysing game-play features, build suggestions, and ranking distributions.

In the case of role determination, AI-based learning model 112 performs an accurate analysis of a Multiplayer Online Battle Arena (MOBA) match by determining roles of the players and their responsibilities, utilizing an algorithm. In this algorithm, AI based learning model 112 uses the statistical information about player-controlled characters, the positional heatmap of the characters, and the items the player-controlled characters chose to buy and their overall behaviour for coaching or training the user. The statistical information about player-controlled characters include, but need not be limited to, roles most played by the player-controlled characters. On the other hand, the positional heatmap of the characters includes, but is not limited to, lanes chosen by the player-controlled characters for moving, in the early stages of the game. AI-based learning model 112 assigns different scores to these factors and determines the player-controlled characters' roles starting from the most confident to the least.

Further, AI-based learning model 112 utilizes game-play features such as scores for indicating the performance of a player in various aspects of the game. These features are mapped to a Gaussian distribution of all performances. This distribution is shifted and scaled to 0-10 range. Residual parts that are less than 0 and greater than 10 are clipped.

Subsequently, AI-based learning model 112 creates item build suggestions based on top rated and up-to-date player-controlled character guides that are created by the community on third-party platforms. These item build suggestions are not static, and adapt according to characteristics of opponent/enemy player-controlled characters. AI-based learning model 112 also provides pre-written tips for playing against certain player-controlled characters that help the player in gaining an advantage.

Finally, AI-based learning model 112 extracts rank distributions from the cumulative group of all players' ranks. The rank distributions determine the percentage of players reaching a specific rank and therefore, determine the challenges in reaching the specific rank. AI-based learning model 112 also considers all players' ranks in a match if an up-to-date information of ranks is available. Thus, AI-based learning model 112 determines the performance more accurately because it is a greater achievement to play well against better opponents than inferior ones.

In another embodiment, AI-based learning model 112 utilizes a neural network structure which predicts the outcome of the game based on the game-play features of all players. After training the AI-based learning model 112 with enough match data, AI-based learning model 112 is used to optimize the performance of a selected player for maximizing the probability of winning the game. AI-based learning model 112 utilizes algorithms such as, but not limited to, gradient descent, differential evolution, and particle swarm optimization algorithms in the optimization stage. Techniques for finding sparse solutions for linear systems are also used in the optimization stage. AI-based learning model 112 tries to stay within realistic constraints by introducing penalty terms to the algorithms. This penalty term gets larger on moving away from the real features. This characteristic prevents AI-based learning model 112 from suggesting infeasible performances. Finally, AI-based learning model 112 displays to users a roadmap corresponding to the users, based on the differences between the suggested performance and the actual one.

In yet another embodiment, AI-based learning model 112 utilizes deep learning and computer vision for analyzing the screen state of the player periodically. AI-based learning model 112 uses image processing techniques such as, but not limited to, low-pass filtering, colour detection, to estimate the locations of players and states of all units from the mini-map.

Further, AI-based learning model 112 utilizes Convolutional Neural Networks (CNNs) for hero and item classification from their avatars. Further, information such as, but not limited to, state of the health and mana bars or the cooldowns of skills are extracted using either image processing techniques or CNNs. With this approach, users receive the suggestions from AI-based learning model 112 in real-time.

AI-based learning model 112 also uses Recurrent Neural Networks (RNNs) in conjunction with CNNs to predict a next state of the user, future location of other players and the outcome of an encounter in the game. AI-based learning model 112 also calculates the winning probability of a team of players.

Further, AI-based learning model 112 includes one or more AI bots which are trained through self-learning with Reinforcement Learning (RL) based on user clusters, to prepare optimal AI replicas of the user. The one or more AI bots are used to generate one or more game-play suggestions based on the user's decisions in certain scenarios.

System 100 further includes a coaching module 114 for coaching the user utilizing AI-based learning model 112 using various techniques such as, but not limited to, statistics, post-game analysis and progress tracking of game-play, for optimizing the performance of the user.

Coaching module 114 provides detailed statistics to players, wherein the players can inspect both their low-level features such as, but not limited to, creep scores and high-level features such as, but not limited to, farming performance index to compare themselves with past performances or with performances of other players. Further, coaching module 114 generates one or more game-play suggestions for the user.

Since statistics sheets do not provide all the details, coaching module 114 employs deeper analysis including post-game analysis which takes place after the game has ended, for providing training or game-play suggestions to the user. In case of post-game analysis, coaching module 114 provides suggestions to the user after the match is over, and the data is available to the service. Depending on the data source, the time that it is available for providing suggestions to the user can vary. However, parsing the replay files takes longer than using the API data.

APIs provide general information about elements such as, but not limited to, players, matches, and leaderboards. However, information about matches are usually the end-game statistics and do not include events that had occurred throughout the game.

For example, official APIs provide timeline data about games, however these are snapshots taken at the beginning of each minute and the events are not detailed enough. The API data still comprise a basis for analysis and are used in methods involving role determination, game-play features, build suggestions, and ranking distributions.

Further, coaching module 114 performs an analysis of replay files by parsing and processing the replay files. The replay files do not contain any graphical component, but consist of event stream lines. While this eliminates the need to use image processing and computer vision systems, other complex problems such as decryption, parsing and processing of these files present themselves. The potential of parsing of replay files is much higher than using API data, and AI-based learning model 112 benefits from the amount of information gained from replay files.

Also, coaching module 114 uses image processing and computer vision techniques to generate videos such as, but not limited to, suggestions and highlights by recreating the replay of the match in the game client on the server side. Coaching module 114 may draw sketches, and create bubbles on these videos, for the user to understand the situation better.

The raw data received from the parsed replay files may be used for reinforcement learning to train Long Short-Term Memory networks (LSTMs) that generate optimal actions based on previous states. The data that the user does not have at the time of playing such as the locations of enemy players in regions without vision, are excluded. The network also outputs predictions such as, but not limited to, win probabilities of team fights or the whole match. The user then receives suggestions based on the decisions made by the network that differ from the user's decision.

Coaching module 114 also performs progress tracking of players by tracking the performance of a player match by match, which provides valuable information such as, for example, whether the users have benefited from the use of the platform or makes suggestions based on certain trends these performances follow.

Based on the progress tracking, coaching module 114 provides one or more game-play suggestions for the user, which help the user to see certain trends followed in the match performances and take necessary actions.

Further, coaching module 114 generates pre-game suggestions and real-time suggestions for the user. Pre-game suggestion are generated prior to starting the game and the real-time suggestions are generated by performing real-time analysis while playing the game without waiting for the end of the game.

Pre-game suggestions consist of item builds, ability upgrades and specific tips and tricks. These are dynamic suggestions that vary according to the opponent player-controlled characters. They are mostly useful for low to middle tier players who may lack information about game dynamics.

Further, pre-game suggestions include suggestions about which player-controlled characters to pick and which ones to ban prior to the game, based on aggregate data of recent matches and strengths and weaknesses of opponents, which may be helpful even for professional players.

Coaching module 114 accomplishes real-time coaching with image processing and computer vision systems as game developers do not provide API endpoints for live match data. After processing the data, coaching module 114 provides real time suggestions to the user for taking necessary actions instantly.

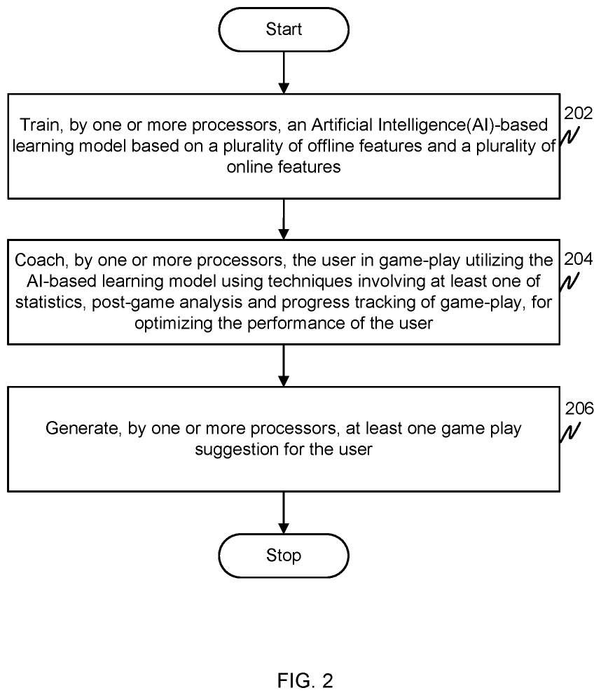

FIG. 2 illustrates a flowchart of a method for assisting game-play of a user in accordance with an embodiment of the invention.

At step 202, AI-based learning model 112 is trained based on a plurality of offline features and a plurality of online feature collected using data collection module 108. The plurality of offline features are extracted from one or more of data collected by one or more game developers, a plurality of Application Programming Interfaces (APIs) and a plurality of replay files associated with game-play.

On the other hand, the plurality of online features are extracted from a screen state of the user using computer vision and image processing techniques. The computer vision and image processing techniques include techniques such as, but not limited to, convolutional neural networks, a low-pass filtering and colour detection, to estimate a location of the user and states of all units from a mini-map.

AI-based learning model 112 is trained based on the plurality of offline features by engineering a plurality of game-play performance features. The plurality of game-play performance features are used in neural network structures, deep learning and computer vision techniques, to prepare a roadmap of the user.

Further, AI-based learning model 112 uses Recurrent Neural Networks (RNNs) to predict one or more of a next state of the user, future location of other players and the outcome of an encounter in the game.

At step 204, coaching module 114 is used to coach the user in game-play utilizing AI-based learning model 112 using techniques such as, but not limited to, statistics, post-game analysis and progress tracking of game-play to optimize the performance of the user. AI-based learning model 112 utilizes algorithms such as, but not limited to, gradient descent, differential evolution, and particle swarm optimization algorithms in the optimization stage, to optimize the performance of the user. AI-based learning model 112 also calculates a winning probability of a team of players.

In an ensuing step 206, coaching module 114 generates one or more game-play suggestions for the user by analyzing the user's statistics, post-game performance and progress of the game-play. Coaching module 114 also generates pre-game suggestions for the user prior to starting the game-play and provides real-time suggestions to the user while playing the game.

In an embodiment, AI-based learning model 112 includes one or more AI bots which are trained through self-learning with Reinforcement Learning (RL) based on user clusters, to prepare optimal AI replicas of the user. The one or more AI bots are used to generate one or more game-play suggestions for the user based on the user's decisions in certain scenarios.

The invention describes methods for assisting game-play of the user utilizing AI-based learning models, which are cost-effective and less time-consuming. Further, the invention supports various online game-play genres from Multiplayer Online Battle Arena (MOBA) to Battle Royale.

The invention utilizes automated and scalable AI to help players improve their game-play and reach higher ranks by providing descriptive and prescriptive analysis with a personalized roadmap. Further, the invention utilizes enhanced processes and techniques for collecting data from different sources, the data related to the user's in-game behaviour, including AI methods to learn the user's behaviour from the data collected, to coach the user using past data and real-time data, and finally to receive feedback from users. Also, the coaching module of the invention provides indication to players of the need to take a small break and to advance stronger in the game. Thus, the invention provides an enhanced technique for coaching the user in game-play and generating one or more game-play suggestions for the user in real-time compared to conventional coaching techniques used in online game-play.

Those skilled in the art will realize that the above recognized advantages and other advantages described herein are merely exemplary and are not meant to be a complete rendering of all of the advantages of the various embodiments of the invention.

The system, as described in the invention or any of its components may be embodied in the form of a computing device. The computing device can be, for example, but not limited to, a general-purpose computer, a programmed microprocessor, a micro-controller, a peripheral integrated circuit element, and other devices or arrangements of devices, which can implement the steps that constitute the method of the invention. The computing device includes a processor, a memory, a non-volatile data storage, a display, and a user interface.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for assisting game-play of a user, the method comprising:
training, by one or more processors, an Artificial Intelligence (AI)-based learning model based on a plurality of offline features and a plurality of online features,
wherein the plurality of offline features are extracted from at least one of data collected by at least one game developer, a plurality of Application Programming Interfaces (APIs) and a plurality of replay files associated with game-play, wherein the plurality of online features are extracted from a screen state of the user; and
coaching, by one or more processors, the user in game-play utilizing the AI-based learning model using techniques involving at least one of statistics, post-game analysis and progress tracking of game-play, for optimizing the performance of the user, wherein the coaching comprises:
generating, by one or more processors, at least one game-play suggestion for the user.

2. The method of claim 1, wherein training the AI-based learning model based on the plurality of offline features comprises engineering, by one or more processors, a plurality of game-play performance features, wherein the plurality of game-play performance features are used in at least one of neural network structures, deep learning and computer vision techniques, to prepare a roadmap of the user.

3. The method of claim 1, wherein the plurality of online features are extracted using computer vision and image processing techniques to estimate a location of the user and states of all units from a mini-map, wherein computer vision and image processing techniques comprise at least one of convolutional neural networks, low-pass filtering and color detection.

4. The method of claim 1, wherein the AI-based learning model uses Recurrent Neural Networks (RNNs) to predict at least one of next state of the user, future location of other players and the outcome of an encounter in the game.

5. The method of claim 1, wherein the AI-based learning model optimizes performance of the user in game-play utilizing at least one of gradient descent, differential evolution and particle swarm optimization algorithms.

6. The method of claim 1, wherein the AI-based learning model calculates a win probability of a team of players.

7. The method of claim 1, wherein an AI-based learning model comprise at least one AI bot, wherein the at least one AI bot is trained through self-learning with Reinforcement Learning (RL) based on user clusters, to prepare optimal AI replicas of the user.

8. The method of claim 7, wherein the least one AI bot generates the at least one game-play suggestion based on the user's decisions in certain scenarios.

9. A system for assisting game-play of a user, the system comprising:
a memory;
a processor communicatively coupled to the memory, wherein the processor is configured to:
train an Artificial Intelligence (AI)-based learning model based on a plurality of offline features and a plurality of online features,
wherein the plurality of offline features are extracted from at least one of data collected by at least one game developer, a plurality of Application Programming Interfaces (APIs) and a plurality of replay files associated with game-play, wherein the plurality of online features are extracted from a screen state of the user; and
coach the user in game-play utilizing the AI-based learning model using techniques involving at least one of statistics, post-game analysis and progress tracking of game-play, for optimizing the performance of the user, wherein the processor is further configured to:
generate at least one game-play suggestion for the user.

10. The system of claim 9, wherein the processor is configured to engineer a plurality of game-play performance features, wherein the plurality of game-play performance features are used in at least one of neural network structures, deep learning and computer vision techniques, to prepare a roadmap of the user.

11. The system of claim 9, wherein the plurality of online features are extracted using computer vision and image processing techniques to estimate a location of the user and states of all units from a mini-map, wherein computer vision and image processing techniques comprise at least one of convolutional neural networks, low-pass filtering and color detection.

12. The system of claim 9, wherein the AI-based learning model uses Recurrent Neural Networks (RNNs) to predict at least one of next state of the user, future location of other players and the outcome of an encounter in the game.

13. The system of claim 9, wherein the AI-based learning model optimizes performance of the user in game-play utilizing at least one of gradient descent, differential evolution and particle swarm optimization algorithms.

14. The system of claim 9, wherein the AI-based learning model calculates a win probability of a team of players.

15. The system of claim 9, wherein an AI-based learning model comprise at least one AI bot, wherein the at least one AI bot is trained through self-learning with Reinforcement Learning (RL) based on user clusters, to prepare optimal AI replicas of the user.

16. The system of claim 15, wherein the least one AI bot generates the at least one game-play suggestion based on the user's decisions in certain scenarios.
